(19) United States
(12) Patent Application Publication
(10) Pub. No.: US 2010/0191553 A1
(43) Pub. Date: Jul. 29, 2010

(54) System and Method for GDS Cryptic Code Interaction with Various Travel Content Sources

(76) Inventors: Michael David McIntosh, (US); James K. Davidson, Miami, FL (US)

Correspondence Address: Gard and Kaslow LLP, One 1st Street, Suite 9, Los Altos, CA, 94022, US

(21) Appl. No.: 12/694,252

(22) Filed: Jan. 26, 2010

Related U.S. Application Data
(60) Provisional application No. 61/148,039, filed on Jan. 28, 2009.

(51) Int. Cl. G06F 15/16; G06Q 10/00; G06Q 50/00

(52) U.S. Cl. 705/5; 709/246

(57) ABSTRACT

Interaction with various travel content sources is supported using any one of various known GDS cryptic code formats. Travel booking requests made in a selected GDS cryptic format are converted for communication with, e.g., a GDS content source, a direct connect content source, and/or a web-based content source and travel booking responses from such travel content sources is converted into a display format of the selected GDS. In this way, users familiar with one GDS cryptic format can continue to use that GDS cryptic format for interaction with GDS content sources of the same or different format, with direct connect content sources in their expected format, and with web-based content sources in their expected format.

### CROSS-REFERENCE TO RELATED APPLICATIONS

This application claims the benefit of U.S. Provisional Patent Application No. 61/148,039 filed on Jan. 28, 2009 and entitled “Farelogix FLX Commando,” which is incorporated herein by reference in its entirety.

### BACKGROUND

1. Field of the Invention

The invention is in the field of travel services, and more particularly to communicating with systems for booking travel services.

2. Related Art

Historically, airline employees were the only ones who could access proprietary airline ticketing systems known as airline reservations systems (ARSs). Access was later given to travel agents to further promote ticket sales and ARSs became known as Computer Reservations Systems (CRSs). Access was then broadened by Global Distribution Systems (GDSs) that interfaced with more than one CRS thus giving travel agents access to multiple airlines. Modern GDSs also support booking hotels, rental cars, cruise lines, etc.

Interaction with these GDSs is via non-intuitive cryptic codes. These cryptic codes typically comprise a series of alphanumeric characters representing such things as departure date, departure airline, return date, return airline, etc. However, because of the origin and evolution of these systems, the cryptic codes for one GDS are typically different than the cryptic codes for another GDS.

Learning a GDS's cryptic codes, represents a significant investment by a travel agent and travel agency. Once having learned the cryptic codes for one GDS, it becomes difficult for a travel agent to move to another agency which uses a different GDS because of their differing codes. This limits the employment mobility of travel agents and the hiring pool of travel agencies.

For these and other reasons, various attempts have been made to support access to GDS systems without having to interact using cryptic codes at all.

One attempt involves the use of a natural language interaction where rather than entering cryptic codes a user simply types (or speaks to a speech recognition system) the request for travel services using standard English language sentence structures. The request is then converted by the system into the appropriate GDS command which is then transmitted to a GDS system. The problem with this approach is that this conversion requires a very sophisticated system to be able to correctly convert such English language sentence structures into the proper GDS commands. This problem is exacerbated by the typical errors that occur with speech recognition systems.

Another attempt involves the use of a computer based graphical user interface (GUI) to specify a request for travel services. In this approach, a user specifies a request for travel services using known GUI interactions such as pull-down menus, button and menu selections, etc. The system then converts the specified request into the appropriate GDS command which is then transmitted to a GDS system. The problem with this approach is that it requires a user already familiar with a GDS's cryptic commands to have to learn yet another interaction mechanism, the GUI itself, and forces the user to forego the speed, power and flexibility available by interacting via known cryptic commands.

A still further attempt involves the use of newly defined computer application programming interfaces (APIs) which are used to specify travel requests. The resulting request is then converted to the appropriate GDS command, similarly to that described above with the GUI approach, and is then transmitted to a GDS system. This, too, requires learning a new interaction model and precludes the benefits of interacting via known cryptic commands.

A further development in the area of requesting travel services is the various travel provider direct connect and Internet web-based systems. Both direct connect and web-based systems allow users to bypass GDS and CRS systems to interact directly with travel content sources, the latter via the World Wide Web. Users do not typically interact with these systems using GDS cryptic commands thus once again precluding the benefits of such known interaction.

What is needed, therefore, is an approach that continues to provide the speed, power and flexibility of known GDS cryptic command interaction while preserving agent and agency training investment and freeing agent mobility and agency hiring.

### SUMMARY

A method for improved travel booking interaction is shown and described herein with reference to a number of specific embodiments.

In one embodiment is a method for booking travel comprising: receiving at a server a travel booking request from a user terminal, the travel booking request in a user-selected GDS cryptic format; converting the travel booking request in the GDS cryptic format to a travel booking request in a normalized format; selecting a travel content source to search; converting the travel booking request in the normalized format to a travel booking request in a format of the selected travel content source; transmitting from the server to the selected travel content source the travel booking request in the format of the selected travel content source; receiving at the server a travel booking response from the selected travel content source, the travel booking response in the format of the selected travel content source; converting the travel booking response in the format of the selected travel source to a travel booking response in the normalized format; converting the travel booking response in the normalized format to a travel booking response in a display format; and transmitting from the server to the user terminal the travel booking response in the display format.

### BRIEF DESCRIPTION OF THE DRAWING

FIG. 1 is a block diagram of one embodiment of the present invention in operation.

FIG. 2 is a flowchart of a general overview of one embodiment of the present method.

FIG. 3 is an exemplary display on a user terminal of one embodiment of the present invention.

### DETAILED DESCRIPTION

Each of the existing GDS content sources such as Amadeus, Sabre, and Travelport support interaction in their own cryptic format. Over time, users (e.g., travel agents) of such GDS content sources become trained in and familiar with the particular cryptic format of the GDS content source they typically access. As a result, these users desire to continue using the particular GDS cryptic format they know.

In addition to differing GDS content sources, the modern world of travel content sources also contains direct connect sources, in which electronic communication occurs directly with providers of travel services in various formats, and web-based sources, in which communication occurs with providers of travel services via the Internet in various web-based formats. Interacting with these other content sources compounds the challenges faced by users desiring to continue using a particular known GDS cryptic format.

The present invention supports interacting with various travel content sources using any one of various known input/output methodologies. In particular, the present invention supports travel booking requests made in a selected GDS cryptic format to be used for interacting with, e.g., a GDS content source, a direct connect content source and/or a web-based content source regardless of their format. In this way, a user familiar with one GDS cryptic format can continue to use that format for interaction with GDS content sources of the same or different format, with direct connect content sources in their expected format, and with web-based content sources in their expected format.

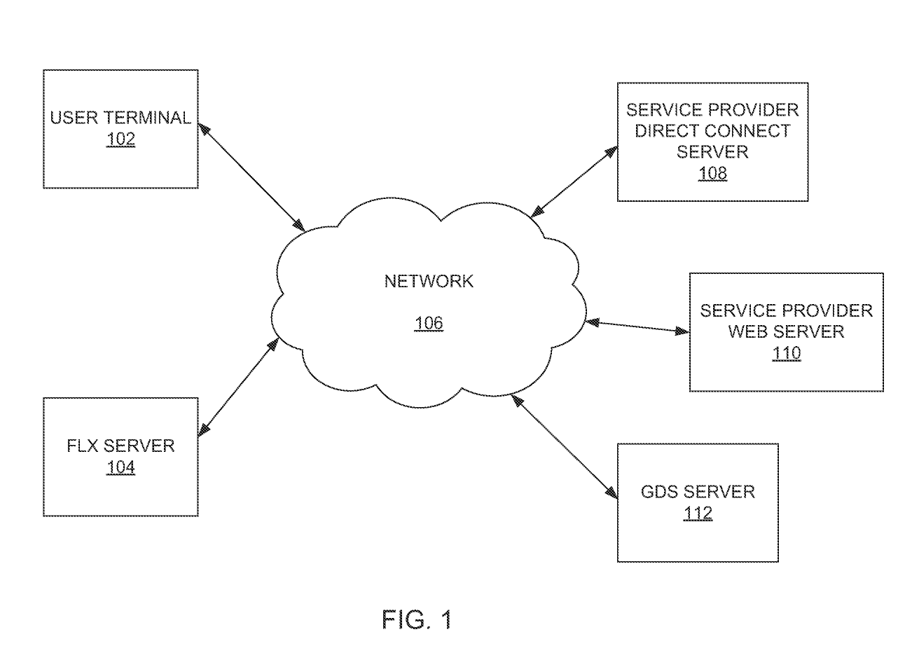

Referring now to FIG. 1, a block diagram of one embodiment of the present invention in operation can be seen. In this embodiment, a user operates user terminal 102 to initiate a travel booking request. In one example, the user is a travel agent and user terminal 102 is a computer of the travel agency where the travel agent works. Such a user enters into user terminal 102 a travel booking request in a user-selected GDS cryptic format. For example, the user may choose to use Amadeus GDS cryptic commands to request availability of air flights between Dallas, Tex., United States of America and Dubai, United Arab Emirates on January 27 by entering the command string “AD27JANDFWDUB” into user terminal 102.

In the prior art, this command string “AD27JANDFWDUB” would be transmitted by user terminal 102 across a network 106 to an Amadeus GDS which would then search for air flight availability based on the user-selected Amadeus GDS cryptic format command string travel booking request. The Amadeus GDS would then return a travel booking response in a display format of the user-selected GDS across network 106 to user terminal 102 for display on user terminal 102. Such prior art interaction is thus all in one GDS format, in this example Amadeus.

By contrast, in this embodiment of the present invention the GDS cryptic format command string “AD27JANDFWDUB” is instead transmitted by user terminal 102 across network 106 to FLX server 104. As explained elsewhere herein, FLX server 104 selects a travel content source to perform the air flight availability search. The selected travel content source could be a Sabre GDS represented by, for example, GDS server 112. FLX server 104 converts the travel booking request in the user-selected Amadeus GDS cryptic format to a travel booking request in the Sabre GDS cryptic format because that is the format expected by the selected Sabre GDS travel content source.

FLX server 104 then transmits the travel booking request in the Sabre GDS cryptic format across network 106 to GDS server 112 for GDS server 112 to perform the requested air availability search. Once this search has been performed by GDS 112, GDS server 112 transmits a travel booking response back across network 106 to FLX server 104. This travel booking response is typically in a display format of the travel content source, e.g. Sabre because GDS server 112 is a Sabre GDS in this example. FLX server 104 converts the travel booking response in the Sabre GDS display format into a travel booking response in the user-selected GDS display format which, in this example, is the Amadeus GDS display format. FLX server 104 then transmits the travel booking response in the user-selected GDS display format across network 106 to user terminal 102 for display on user terminal 102.

As evident by this example, although the user chose to interact in the Amadeus GDS cryptic format, other processing occurred in the Sabre GDS cryptic format. This thus allows a user to continue interacting in a chosen GDS cryptic format while opening up the processing to systems that interact using other GDS cryptic formats.

Likewise, such processing is not limited to only a single travel content source nor limited to only GDS travel content sources. As such, in various embodiments of the present invention the travel booking request can also be sent to other travel content sources in their expected interaction format. For example, FLX server 104 can select another travel content source such as service provider direct connect server 108 and then convert the user-selected Amadeus GDS cryptic format travel booking request into a travel booking request in the format of service provider direct connect server 108 before transmitting such request across network 106 to service provider direct connect server 108 for performing the air availability search. Similarly, FLX server 104 can select service provider web server 110 as the travel content source and convert the user-selected Amadeus GDS cryptic format travel booking request into a travel booking request in the format of service provider web server 110 before transmitting such request across network 106 to service provider web server 110 for performing the air availability search. FLX server 104 would then receive back across network 106 a travel booking response from service provider direct connect server 108 and/or service provider web server 110 in their respective display format and then convert the travel booking response into the user-selected GDS display format. FLX server 104 would then transmit the converted response(s) across network 106 to user terminal 102 for display on user terminal 102. In this fashion, again, the user operating user terminal 102 can continue to interact in their selected GDS cryptic format yet the desired travel search can be performed by travel content sources that interact using other GDS cryptic formats or other expected formats. And further, the user operating user terminal 102 can interact in their selected GDS cryptic format yet have booking requests and responses be handled by any one or more of a variety of travel content sources in the format of the travel content sources, including, for example, a GDS operating in the user-selected GDS cryptic format.

It is to be understood that the air travel availability requests and responses described herein are merely examples and that the described approach is equally applicable to any desired and applicable travel or travel-related arrangements.

It is to be understood that the user of user terminal 102 can be anyone requesting travel booking information and is not limited to the specific example of a travel agent. It is also to be understood that user terminal 102 can be any form of terminal or standalone computing system or device (including desktop computer, laptop computer, tablet computer, handheld computing device, cellular telephone, etc.) or can be the combination of such terminal or standalone computing system or device and a local server or computing system of, for example, a travel agency which handles communications and other functionality of the agency. As such, explanation of requests from user terminal 102 across network 106 and responses received by user terminal 102 across network 106 may pass through such local server or computing system.

It is to be understood that FLX server 104 can comprise more than one server and/or computing system to handle the communications and processing described herein. It is to be further understood that FLX server 104 can include a computer readable storage medium having embodied thereon one or more programs, the one or more programs being executable by a processor to perform the method of the functionality described herein.

It is to be understood that network 106 is intended to cover any combination of wired and/or wireless local area network, wide area network, cellular telephone network (voice and/or data), and/or the Internet to support the functionality described herein.

It is to be understood that GDS server 112 can be any GDS travel content source and can comprise more than one server and/or computing system to handle the communications and processing described herein. It is likewise to be understood that service provider direct connect server 108 can be any service provider direct connect travel content source and can comprise more than one server and/or computing system to handle the communications and processing described herein. It is likewise to be understood that service provider web server 110 can be any service provider web-based travel content source and can comprise more than one server and/or computing system to handle the communications and processing described herein.

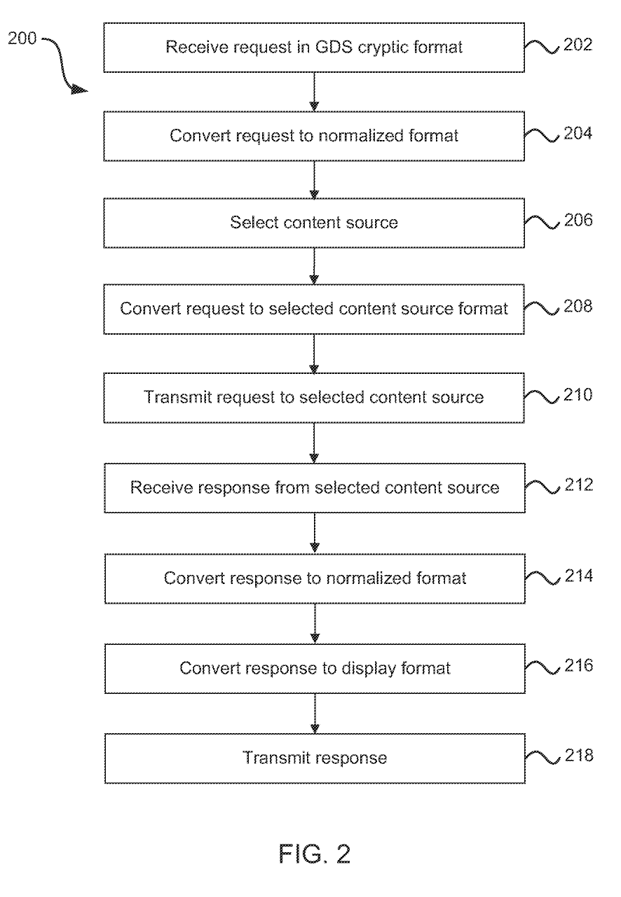

Referring now to FIG. 2, a flowchart of a general overview of one embodiment of the present method can be seen. According to the method 200, a travel booking request in a user-selected GDS cryptic format is received in step 202. In some embodiments, a tag or marker identifying the GDS cryptic format of the request is also received in step 202. In other embodiments, the GDS cryptic format of the request is simply determined from the content of the request itself. The request is converted from the user-selected GDS cryptic format into a normalized format in step 204. A travel content source is selected in step 206 to perform the search. The travel booking request in the normalized format is converted to a travel booking request in the format of the selected content source in step 208. The travel booking request in the format of the selected content source is transmitted to the selected content source in step 210. A travel booking response in the format of the travel content source is received in step 212. The travel booking response in the format of the travel content source is converted to a travel booking response in the normalized format in step 214. The travel booking response in the normalized format is converted to a travel booking response in the user-selected GDS display format in step 216. The travel booking response in the user-selected GDS display format is transmitted in step 218. One example of method 200 will now be explained in greater detail in the context of the embodiment of FIG. 1. A user operating user terminal 102 enters a travel booking request in a user-selected GDS cryptic format (e.g., “AD28APRDXBBOM” which is a search request in the Amadeus GDS cryptic format for air travel availability between Dubai, United Arab Emirates and Mumbai, India on April 28). The travel booking request command string is transmitted across network 106 to FLX server 104 in step 202. FLX server 104 converts the request in the user-selected GDS cryptic format into a normalized format in step 204.

In one embodiment this conversion is accomplished by FLX server 104 first loading a Regular Expression definition file for the user-selected GDS cryptic format, for example:

...
lowfaresearch := \hat{ }(FXC)%($org)%($datecity)%($datecity)?
airavailability :=
\hat{ }(AN|AD)+(\s)*%($date)%($org)%($dst)%($timewindow)?(([\x2F]A)+%($carrierlis
t))?
schedulesavailability :=
\hat{ }(SN|SD)+(\s)*%($date)%($org)%($dst)%($timewindow)?(([\x2F]A)+%($carrierlist
))?
...

With the travel booking request command string matching a Regular Expression in the definition file that is assigned to “airavailability”, FLX server 104 invokes JavaScript airavailability.xjs which converts the user-selected GDS cryptic command string into a generic Regular Expression (RegEx) Extensible Markup Language (XML) string as follows:

<rex><s0>AD28APRDXBBOM</s0><s1>AD</s1><s2></s2><s3>28APR</s3><s4
>28</s4><s5>APR</s5><s6>DXB</s6><s7>BOM</s7><s8></s8><s9></s9><s10>
</s10><s11></s11><s12></s12><s13></s13><s14></s14><s15></s15><s16></s16
><s17></s17></rex>

This RegEx XML string contains the itemized GDS cryptic code command parameters parsed into XML according to the Regular Expression for airavailabity. For example, the code for the departure city of Dubai, “DXB”, is shown here in the XML node <s6>.

FLX server 104 retrieves this XML string using a JS object, which is a JavaScript extension object as follows:

var strCommand = commando.Command;
var xslt = new xxTransform( );
if (!xslt)
throw “Could not create transform engine”;
var xsl = devpath + “airavailabilityrq.xsl”;
var aaRQ = xslt.Transform(xsl.toString( ), strCommand);
if (!aaRQ)
throw “Invalid command format” + xslt.LastError;

This RegEx XML version of the command string is then passed through an Extensible Stylesheet Language (XSL) stylesheet to become a FLX server 104 air availability request (AirAvailabilityRQ) web services request as follows:

<AirAvailabilityRQ ScheduleOnly=“N” NumberOfAlternates=“50”>

| | <NumberInParty>1</NumberInParty> | |
|---|---|---|
| − | <OriginDestination> | |
| | − | <Departure> |

<CityCode>DXB</CityCode>
<Date>2009-04-28</Date>

| | </Departure> |
|---|---|
| − | <Arrival> |

<CityCode>BOM</CityCode>

| | </Arrival> |
|---|---|
| − | <Preferences Sort=“NEUTRAL”> |

<Time />
<Airline />

</Preferences>

</OriginDestination>

</AirAvailabilityRQ>

FLX server 104 in step 206 selects which travel content source(s) is to handle the request based on the received travel booking request. In one embodiment, FLX server 104 simply selects a GDS travel content source that matches the user-selected GDS cryptic format. In another embodiment, FLX server 104 selects a GDS travel content source, a service provider direct connect travel content source and/or a service provider web-based travel content source as specified by the travel agency employing the travel agent user. In another embodiment, FLX server 104 selects more than one travel content source and/or all available travel content sources, as desired or specified.

The travel booking request in the normalized format is converted to a travel booking request in the format of the selected content source, e.g., service provider direct connect server 108, service provider web server, 110, and/or GDS server 112, in step 208. In some embodiments in which the selected content source is a service provider direct connect server, converting a travel booking request in the normalized format to a travel booking request in the format of the selected content source is accomplished via XSL transformations from one XML format to another XML format. In other embodiments, such conversion is accomplished via mapping between the normalized format and a known protocol defined by or used by the selected content source, as in the case of Electronic Data Interchange for Administration, Commerce and Transport (EDIFACT) and/or a Product Availability Offering Request (PAOREQ), as used by various airlines and other content sources. In still other embodiments where a selected content source uses proprietary or non-standard interfaces, such conversion is accomplished via parsing the request in the normalized format and reformatting it into the structure expected by the selected content source.

The travel booking request in the format of the selected content source is transmitted from FLX server 104 across network 106 to the selected travel content source, e.g., service provider direct connect server 108, service provider web server, 110, and/or GDS server 112, in step 210.

A travel booking response is received by FLX server 104 across network 106 from the selected travel content source in step 212.

The travel booking response is converted in step 214 to a normalized web services XML response, for example:

<AirAvailabilityRS>

| − | <InfoGroup> | |
|---|---|---|
| | − | <ForInfo Source=“EK”> |

<Text>TUE 28APR09 DUBAI-MUMBAI 28/0001
28/2359 G*EK</Text>
<Text>FREE CHAUFFEUR DRIVE FOR EK F/J
PAX-SEE EK PAGES IN YR GDS</Text>

| | |
|---|---|
| | </ForInfo> |
| − | <ForInfo Source=“1A”> |

<Text>** AMADEUS AVAILABILITY - AN **
92 TU 28APR 0000</Text>

| | | </ForInfo> |
|---|---|---|
| | </InfoGroup> | |
| − | <OriginDestination Source=“*” DepartureCode=“DXB” | |
| | ArrivalCode=“BOM”> | |
| | − | <Flight Source=“EK”> |

| | |
|---|---|
| − | <Segment ChangeOfAirport=“N” Source=“EK”> |

| | |
|---|---|
| − | <Departure> |

<AirportCode>DXB</AirportCode>
<AirportName>Dubai, AE</AirportName>
<Date>2009-04-28</Date>
<Time>04:00</Time>
<Terminal>3</Terminal>

| | |
|---|---|
| | </Departure> |
| − | <Arrival> |

<AirportCode>BOM</AirportCode>
<AirportName>Mumbai, IN</AirportName>
<Date>2009-04-28</Date>
<ChangeOfDay />
<Time>08:15</Time>
<Terminal>2</Terminal>

</Arrival>

Continuing with step 214, the normalized travel booking response is converted by JavaScript airavailability.xjs to a normalized screen matrix XML again using an XSL style sheet, for example:

var display =

xslt.Transform(“airavailability-response.xsl”, strRsp);

such that the resulting XML has the following format:

<display>

| | |
|---|---|
| − | <line> |

<text col=“1”>** STANDARD AVAILABILITY - AD
**</text>
<text col=“33”>BOM</text>
<text col=“37”>MUMBAI,IN</text>
<text col=“66”>TUE</text>
<text col=“70”>28APR</text>
<text col=“76”>0000</text>

| | |
|---|---|
| | </line> |
| − | <line> |

<text col=“1”>**</text>
<text col=“4”>TUE 28APR09 DUBAI-MUMBAI 28/0001
28/2359 G*EK</text>

| | |
|---|---|
| | </line> |
| − | <line> |

<text col=“1”>**</text>
<text col=“4”>FREE CHAUFFEUR DRIVE FOR EK F/J
PAX-SEE EK PAGES IN YR GDS</text>

| | |
|---|---|
| | </line> |
| − | <line> |

<text col=“1”>**</text>
<text col=“4”>** AMADEUS AVAILABILITY - AN **
92 TU 28APR 0000</text>

| | |
|---|---|
| | </line> |
| − | <line> |

<text col=“1”>1</text>
<text col=“5”>EK0504</text>
<text col=“14”>F4</text>
<text col=“17”>A4</text>
<text col=“20”>J7</text>
<text col=“23”>C7</text>

FLX server 104 then converts the booking response in the normalized format into a booking response in a display format in step 216. In various embodiments this conversion is accomplished in essentially the reverse fashion of that described with respect to step 208.

The display format travel booking response is then transmitted in step 218 from FLX server 104 across network 106 to user terminal 102 for display on user terminal 102.

This process can essentially be repeated by a second travel booking request being received by FLX server 104 that is based on the travel booking response transmitted from FLX server 104 to user terminal 102. For example, the user of user terminal 102 can choose to book a travel service offering in the transmitted and displayed travel booking response displayed on user terminal 102 by generating a second travel booking request indicating this choice which new travel booking request is then transmitted from user terminal 102 and received by FLX server 104. In another example, the user of user terminal 102 can choose to generate a second travel booking request indicating a different scope of search for travel services (e.g., dates, times, locations, service provider, etc.) which is then transmitted from user terminal 102 and received by FLX server 104.

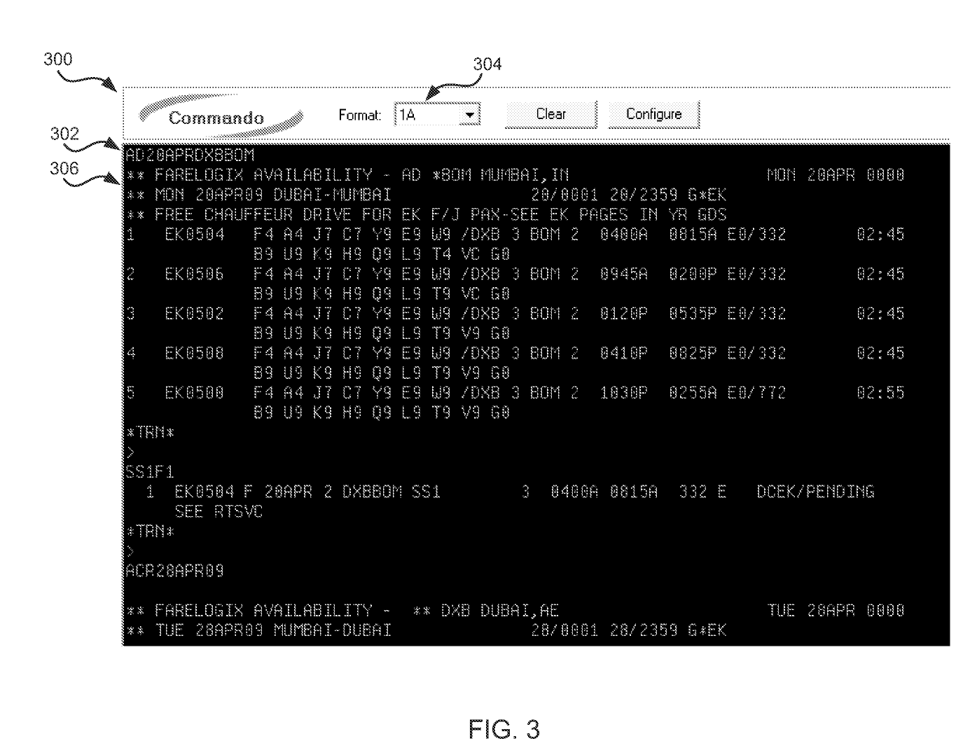

Referring now to FIG. 3, an exemplary display 300 on user terminal 102 according to one embodiment of the present invention can be seen. In this display example, the user-selected GDS cryptic format command “AD20APRDXBBOM” 302 has been entered in user terminal 102 as indicated by reference 302. This is a travel booking request using the Amadeus GDS cryptic code command format which in this particular example is, as stated elsewhere herein, for availability of air flights between Dubai, United Arab Emirates and Mumbai, India on April 20. The user has selected the Amadeus GDS cryptic code format as indicated by the pull-down menu selection of “1A” at reference 304. This selection can by any known selection means including typical computing system GUI such as pull-down menus (as shown in the figure), button selection, etc., or simply typing into a display field a desired GDS. In one embodiment, this selection is also transmitted from user terminal 102 to FLX server 104, in addition to the travel booking request itself, to inform FLX server 104 of the user-selected GDS format being used. Lastly, in response to the travel booking request, the resulting travel booking response is received and displayed is shown as indicated by reference 306.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, the description and the drawing should not be considered in a limiting sense, as it is understood that the present invention is in no way limited to only the embodiments illustrated.

What is claimed is:

1. A method for booking travel comprising:
receiving at a server a travel booking request from a user terminal, the travel booking request in a user-selected GDS cryptic format;
converting by the server the travel booking request in the GDS cryptic format to a travel booking request in a normalized format;
selecting a travel content source to search;
converting by the server the travel booking request in the normalized format to a travel booking request in a format of the selected travel content source;
transmitting from the server to the selected travel content source the travel booking request in the format of the selected travel content source;
receiving at the server a travel booking response from the selected travel content source, the travel booking response in the format of the selected travel content source;
converting by the server the travel booking response in the format of the selected travel source to a travel booking response in the normalized format;
converting by the server the travel booking response in the normalized format to a travel booking response in a display format; and
transmitting from the server to the user terminal the travel booking response in the display format.

2. The method of claim 1 wherein selecting the travel content source to search is based on the user-selected GDS cryptic format.

3. The method of claim 1 wherein the travel booking request is received at the server from a user terminal of a travel agency.

4. The method of claim 3 wherein selecting the travel content source to search is specified by the travel agency.

5. The method of claim 1 wherein the user-selected GDS cryptic format is Amadeus.

6. The method of claim 1 wherein the user-selected GDS cryptic format is Sabre.

7. The method of claim 1 wherein the user-selected GDS cryptic format is Travelport.

8. The method of claim 1 wherein the selected travel content source is a GDS server.

9. The method of claim 8 wherein the GDS server is an Amadeus server.

10. The method of claim 8 wherein the GDS server is a Sabre server.

11. The method of claim 8 wherein the GDS server is a Travelport server.

12. The method of claim 1 wherein the selected travel content source is a direct connect server.

13. The method of claim 12 wherein the direct connect server is American Airlines.

14. The method of claim 12 wherein the direct connect server is an airline.

15. The method of claim 12 wherein the direct connect server is a cruise line.

16. The method of claim 1 wherein the selected travel content source is a web server.

17. The method of claim 16 wherein the web server is American Airlines.

18. The method of claim 16 wherein the web server is an airline.

19. The method of claim 16 wherein the web server is a cruise line.

20. The method of claim 1 further comprising receiving at the server a second travel booking request from the user terminal, the received second travel booking request being based on the travel booking response transmitted from the server to the user terminal.
